(19) United States
(12) Patent Application Publication
(10) Pub. No.: US 2021/0282436 A1
(43) Pub. Date: Sep. 16, 2021

(54) PROCESS AND APPARATUS FOR THE PRODUCTION OF A MEAT ANALOGUE

(71) Applicant: Mars, Incorporated, McLean, VA (US)

(72) Inventor: Johannes Paul SCHLEBUSCH, Verden (DE)

(73) Assignee: Mars, Incorporated, McLean, VA (US)

(21) Appl. No.: 17/257,546

(22) PCT Filed: Jul. 1, 2019
(86) PCT No.: PCT/US2019/040116

§ 371 Date: Dec. 31, 2020

(30) Foreign Application Priority Data
Jul. 2, 2018 (DE) 10 2018 115 955 2

(51) Int. Cl. A23L 13/60; A23J 3/04; A23J 3/22; A23K 10/20; B26D 3/18; B26D 3/22

(52) U.S. Cl. CPC A23L 13/60; A23J 3/04; B26D 3/22; A23K 10/20; B26D 3/185; A23J 3/22

(57) ABSTRACT

Processes for the production of a meat analogue include: a) preparing a meat batter comprising protein by mixing water, raw material of meat and/or meat by-product, and optionally further ingredients, in a mixer, b) conveying the meat batter obtained in step a) by means of a first positive displacement pump to a single heating unit comprising a single scraped surface heat exchanger, c) heating the meat batter in the single heating unit to a temperature above the melting temperature of the protein to produce a heat-treated product, d) transferring the heat-treated product of step c) to a cooling unit by means of a second positive displacement pump, e) cooling the heat-treated product by moving through the cooling unit, so that the heat-treated product reaches a temperature below water boiling temperature at ambient pressure when exiting the cooling unit, and f) dividing the cooled heat-treated product into pieces.

### CROSS-REFERENCE TO RELATED APPLICATIONS

This application is a U.S. national stage patent application of International Patent Application No. PCT/US2019/040116, filed Jul. 1, 2019, which claims the priority of DE Application No. 10 2018 115 955.2, filed Jul. 2, 2018, the entire of each of which are incorporated herein by reference.

### FIELD OF THE DISCLOSURE

The presently disclosed subject matter relates to processes and apparatuses for the production of food components, and more particularly meat analogues for use in pet or human foods.

### BACKGROUND OF THE DISCLOSURE

Pet foods have long been manufactured from animal by-products and non-animal derived ingredients to prepare high quality food that provides pets with the required nutrient profile without competing with the human food demand for meat. As the global population increases, the global demand for high protein foods including meat is expected to increase. Thus, there is a growing need for pet foods prepared from meat analogues which meet the nutritional needs of pets and which are also sufficiently palatable.

Meat analogues are typically prepared by mixing, chopping and emulsifying a mixture of raw meat ingredients such as beef, pork, lamb, chicken or combinations thereof obtained from the muscle tissue and meat by-products. These raw meat ingredients are then mixed with various dry ingredients, for example vegetable by-products, starches, vitamins, minerals, gums, and glutens, to make a meat emulsion. The resulting meat emulsion is then extruded into a continuous slab or sheet that is further transferred into an oven or a steam tunnel where the slab or sheet is cooked by exposing it to heat. The cooked slab or sheet is then cooled (optionally), chopped into pieces, a sauce preparation or the like can be optionally added and the meat analogues are packed and sterilized.

WO 2016/055940 A1 discloses a method for producing non-meat food products having appearance and texture of cooked meat. The method comprises mixing dry ingredients comprising vegetable proteins with wet ingredients comprising at least one of water or oil to form a non-meat dough; heating the non-meat dough under pressure at a temperature from 110-180° C.; and gradually cooling the heated non-meat dough to form a non-meat food product. EP 1 231 846 B2 discloses a method for producing a meat emulsion product. The method comprises forming a meat emulsion containing at least 29% by weight protein, 4-7% by weight fat and 49-53% by weight moisture; comminuting and heating the meat emulsion to a temperature of 140-154° C.; introducing the emulsion into a processing zone; subjecting the meat emulsion to a pressure of 1380-2415 kPa; and discharging the meat emulsion from the zone. WO 2015/172002 A2 discloses a method for producing meat-like chunks, wherein a meat slurry is introduced to a first scraped heat exchanger at a pressure of at least 1241 kPa and heat is applied to the first scraped heat exchanger to produce a first heat-treated meat product having a temperature of 38-66° C. The first heat-treated meat product is then transferred to a second scraped heat exchanger and heat is applied to the second scraped heat exchanger to produce a second heat-treated meat product having a temperature of 60-85° C. The second heat-treated meat product is then transferred to a steam tunnel for further processing. The process fails to provide a sufficient meat-like fibrous structure of the chunks.

Food Reviews International, 8(2), 235-275 (1992) or International Journal of Food Science and Technology 1999, 34, 195-207, disclose a protein texturization process by extrusion cooking at high moisture levels and high moisture food extrusion, respectively, utilizing twin-screw extruders. Using a twin-screw extruder, unit operations as follows are performed within just one equipment, namely, mixing of ingredients to obtain a homogeneous distribution of all recipe components, conveying material, heating of material, wherein heat is typically provided from heated surfaces of the twin-screw extruder and via conversion of mechanical energy into thermal energy by specific screw designs, and pumping for creating pressure.

The use of twin-screw extruders is typically limited for only higher viscosities of, e.g., 140,000-210,000 cP, as otherwise the screw would rotate in the too low viscosity liquid which cannot be forced through a cooling die. While twin-screw extrusion is for high moisture extrusion, the extruders require high capital cost. Additionally, processes for the production of a meat analogue are known utilizing heat exchangers for heating meat emulsions without any inner moving parts, which, thus, tend to show fouling effects over processing time.

Thus, there remains a need for improved and stable processes and apparatuses for performing the same in the production of meat analogues with improved uniformity and/or palatability. The disclosed subject matter addresses these and other needs.

### SUMMARY OF THE DISCLOSURE

The present disclosure provides novel processes for the production of meat analogues which are more stable than existing processes and apparatuses for performing the same. Such novel processes can be more precisely controlled during operation and surprisingly and advantageously provide meat analogues with improved uniformity and/or palatability as compared to existing meat analogues. Processes of the present disclosure allow for high moisture extrusion with low cost equipment and provide for the processing of materials having low viscosities. Further, in certain embodiments, such processes can advantageously be performed in one heating step.

Further, the meat analogues provided herein have unexpected improved palatability as compared to meat analogues prepared by conventional processes. The present disclosure further provides apparatuses for the production of meat analogues according to the disclosed processes. The present disclosure also provides processes for producing pet or human food from the meat analogues of the present disclosure.

The present disclosure provides processes for the production of a meat analogue comprising: a) preparing a meat batter comprising protein by mixing water, raw material of meat and/or meat by-product, and optionally further ingredients, in a mixer; b) conveying the meat batter by means of a first positive displacement pump to a single heating unit comprising a single scraped surface heat exchanger; c) heating the meat batter in the single heating unit to a temperature above the melting temperature of the protein to produce a heat-treated product; d) transferring the heat-treated product to a cooling unit by means of a second positive displacement pump; e) cooling the heat-treated product by moving through the cooling unit, so that the heat-treated product reaches a temperature below water boiling temperature at ambient pressure when exiting the cooling unit, and f) dividing the cooled heat-treated product into pieces.

In certain embodiments, the meat batter can be heated to a temperature of from about 140° C. to about 170° C.

In certain embodiments, the single heating unit can be operated with different temperature zones of applied heating medium and/or steam along its length, optionally with increasing temperatures from an entrance to an exit of the single heating unit.

In certain embodiments, the single heating unit can be operated with an incremental temperature increase.

In certain embodiments, the single heating unit can have a first temperature zone of about 50° C. at the entrance of the single heating unit, and a second temperature zone of about 170° C. at the exit of the single heating unit. In certain embodiments, the single heating unit can include at least three different temperature zones, or at least five different temperature zones of about 50° C., about 80° C., about 110° C., about 140° C. and about 170° C., respectively, from the entrance to the exit of the single heating unit.

In certain embodiments, in step c), a temperature difference of the meat batter to a surface of the single heating unit, at all distances from the entrance of the single heating unit, can be between about 7° C. and about 50° C. or between about 10° C. and about 30° C.

In certain embodiments, a viscosity of the meat batter prepared in step a) can be from about 20,000 cP to about 150,000 cP, as measured on a Brookfield instrument with spindle 7 at 15 RPM at room temperature (25° C.).

In certain embodiments, an outlet temperature of the heat-treated material from the single heating unit ca be from about 150° C. to about 170° C.

In certain embodiments, the heat-treated product can be cooled in the cooling unit to a temperature of less than about 80° C.

In certain embodiments, the meat analogue produced can have improved palatability as compared to meat analogues prepared by conventional processes.

The present disclosure provides for meat analogues prepared according to the processes as disclosed herein and for human and pet food products including the same. In certain embodiments, the present disclosure provides a human food product which can include the meat analogue prepared in accordance with processes of the present disclosure. In certain embodiments, the present disclosure provides a pet food product which can include the meat analogue prepared in accordance with the processes of the present disclosure.

The present disclosure provides an apparatus for the production of a meat analogue comprising: i) a mixer; ii) a first positive displacement pump, located downstream the mixer; iii) a single heating unit comprising a single scraped surface heat exchanger; located downstream the first positive displacement pump; iv) a second positive displacement pump, located downstream the single heating unit; v) a cooling unit, located downstream the second positive displacement pump; and vi) a dividing unit, located downstream the cooling unit.

In certain embodiments, the first and second positive displacement pumps can be gear pumps or rotary lobe pumps.

In certain embodiments, the apparatus can additional comprise one or more of: i) a grinder; ii) a conditioning unit; iii) a packaging unit; or iv) a sterilization unit installed downstream of the heating unit.

In certain embodiments, the single heating unit can be operable to have different temperature zones of applied heating medium and/or steam along its length, optionally with increasing temperatures from an entrance to an exit of the single heating unit.

In certain embodiments, the single heating unit can be operable to have an incremental temperature increase.

In certain embodiments, the cooling unit can be operable to cool a heat-treated product to a temperature of less than about 80° C.

In certain embodiments, the dividing unit can be operable to perform a first cutting using a grid cutter followed by a second cutting using a rotary cutter.

### BRIEF DESCRIPTION OF THE FIGURES

FIG. 1 is a graph illustrating preference feeding test results of pet food products including meat analogues prepared by processes in accordance with the present disclosure according to Example 3.

### DETAILED DESCRIPTION OF THE DISCLOSURE

The present disclosure provides novel processes for the production of meat analogues and apparatuses for use in the same. Meat analogues produced in accordance with the methods and apparatuses of the present disclosure exhibit improved uniformity and/or palatability as compared to existing meat analogues. Such processes can be more precisely controlled during operation and advantageously allow for high moisture extrusion with low cost equipment and provide for the processing of materials having low viscosities. Further, in certain embodiments, such processes can advantageously be performed in one heating step. The heating step can include multiple temperature zones with different temperatures. Additionally, the meat analogues prepared in accordance with the processes of the present disclosure have unexpected improved palatability as compared to meat analogues prepared by conventional processes. The present disclosure further provides processes for producing pet or human food from the meat analogues of the present disclosure.

For clarity and not by way of limitation, this detailed description is divided into the following sub-portions:

### 5.1. Definitions;

5.2. Methods of making meat analogues; and
5.3. Methods of using meat analogues.

### 5.1 Definitions

The terms used in this specification generally have their ordinary meanings in the art, within the context of this disclosure and in the specific context where each term is used. Certain terms are discussed below, or elsewhere in the specification, to provide additional guidance in describing the compositions and methods of the disclosure and how to make and use them.

As used in the specification and the appended claims, the singular forms “a,” “an” and “the” include plural referents unless the context clearly dictates otherwise. Thus, for example, reference to “a compound” includes mixtures of compounds.

As used herein, the terms “about” or “approximately” means within an acceptable error range for the particular value as determined by one of ordinary skill in the art, which will depend in part on how the value is measured or determined, i.e., the limitations of the measurement system. For example, “about” can mean within three or more than three standard deviations, per the practice in the art. Alternatively, “about” can mean a range of up to 20%, preferably up to 10%, more preferably up to 5%, and more preferably still up to 1% of a given value. Also, particularly with respect to systems or processes, the term can mean within an order of magnitude, preferably within five-fold, and more preferably within two-fold, of a value.

As used herein, the terms “animal” or “pet” as used in accordance with the present disclosure refers to domestic animals including, but not limited to, domestic dogs, domestic cats, horses, cows, ferrets, rabbits, pigs, rats, mice, gerbils, hamsters, goats, and the like. Domestic dogs and cats are particular non-limiting examples of pets. The term “animal” or “pet” as used in accordance with the present disclosure can further refer to wild animals, including, but not limited to bison, elk, deer, venison, duck, fowl, fish, and the like.

As used herein, the terms “animal feed,” “animal feed compositions,” “pet food,” “pet food article,” or “pet food composition” are used interchangeably herein and refer to a composition intended for ingestion by an animal or pet. Pet foods can include, without limitation, nutritionally balanced compositions suitable for daily feed, such as kibbles, as well as supplements and/or treats, which can be nutritionally balanced. In an alternative embodiment, the supplement and/or treats are not nutritionally balanced. In that regard, the terms “animal feed,” “animal feed compositions,” “pet food,” “pet food article,” or “pet food composition” encompass both pet treats and pet primary foods, as defined herein.

As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

As used herein, the terms “denatured” or “denaturation” related to proteins means that denatured proteins have lost their three-dimensional structure. Denatured proteins can exhibit a wide range of characteristics, from loss of solubility to protein aggregation. Someone skilled in the art is well aware what is to be understood under a denatured protein.

As used herein, the terms “dividing” or “divided” refer to any operation to comminute a product, for example cutting, ripping, tearing, squeezing, hammer milling, etc.

As used herein, references to “embodiment,” “an embodiment,” “one embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, the terms “palatability” or “palatable” refer to being desirable to the palate or taste. Further, the terms “palatability” or “palatable” as used herein refer to the extent to which a pet food product appeals to the palate or taste of an animal. This is suitable measured by feeding tests, e.g., difference tests or ranking tests. In certain embodiments, “palatability” can mean a relative preference for one food product over another. For example, when an animal shows a preference for one of two or more food products, the preferred food product is more “palatable”, and has “enhanced palatability” or “increased palatability”. In certain embodiments, the relative palatability of one food product compared to one or more other food products can be determined, for example, in side-by-side, free-choice comparisons, e.g., by relative consumption of the food products, or other appropriate measures of preference indicative of palatability.

As used herein the term “meat analogue” refers to a meat substitute suitable for use in pet or animal food as a meat replacement, which can suitably be a “chunk”. The meat analogue can have sensory attributes similar to cooked meat. Meat analogues can be incorporated into pet or human food products. They can be particularly suitable for inclusion in wet pet food products of all types, e.g., they can be incorporated into pates, loaves and chunk in sauce formats. They can be particularly suitable for inclusion in “chunk in sauce” products, e.g., “chunk and gravy”, “chunk and jelly” or “chunk and mousse” products. The meat analogues can be typically between about 7 mm and about 30 mm, about 8 mm and about 30 mm, or about 13 mm and about 20 mm in length along the longest dimension. The meat analogues can have a nutritional composition of moisture, protein, fat, and ash. For example, the meat analogues can suitably have a nutrient composition of about 45% to about 65% moisture, or about 50% to about 56% moisture, about 25% to about 36% protein, about 4% to about 13% fat, and about 1% to about 3% ash.

As used herein, the term “meat batter” refers to a thick mixture of water and other substances derived from raw material of meat and/or meat by products and optionally other ingredients. They are not emulsions such as mayonnaise or milk, but are dispersions of fat particles and air bubbles in a complex phase composed of water, solubilized meat protein, cellular components and other ingredients. They can also be referred to as a “meat emulsion” or a “meat slurry”. These terms are well understood in the art and are used interchangeably. Typically, they comprise a continuous phase which is an aqueous medium containing soluble proteins, soluble muscle constituents, segments of muscle fibers, connective tissue fibers, bones, etc. and optionally materials of plant origin materials such as proteins and/or starches and/or fibres and/or minerals. Meat batters/emulsions/slurries can also contain further additives as is common in the art. Meat batters can be obtained by known methods, e.g., by fragmenting fresh and/or frozen meat obtained from animal skeletal muscle to generate meat fragments which can be blended with water, one or more binding agent(s), and optionally other ingredients. Frozen meat can be suitably chopped, crushed and ground to create a meat batter/slurry/emulsion. Typically, the ground meat slurry will be size-reduced by use of a system comprising rotating and static elements, for example by means of rotating knives on die plates, and finally passes through a hole of characteristic diameter. In various embodiments, the maximum diameter of the hole can be about 0.5 mm, about 1 mm, about 2 mm, about 3 mm, about 4 mm, about 5 mm, about 6 mm, about 7 mm, about 8 mm, about 9 mm, and/or about 10 mm. The resulting finer ground meat emulsion can suitably be transferred to a mixer where water, dry ingredients (e.g., protein powder of vegetable origin) and liquid ingredients (e.g., colourants) can be optionally added to provide a meat batter.

As used herein, the terms “nutritionally complete” or “nutritionally balanced” in reference to a composition means that the composition has known required nutrients to sustain life in proper amounts and proportion based on recommendations of recognized authorities, including governmental agencies. For example, and not by way of limitation, in the context of pet food, such agency can be the United States Food and Drug Administration's Center for Veterinarian Medicine, the American Feed Control Officials Incorporated, in the field of pet nutrition, except for the additional need for water. For example, and not by way of limitation, in the context of human food, such agency can be the United States Food and Drug Administration (FDA).

As used herein, the term “protein” refers to one or more proteins suitably provided by one or more of the raw materials. The protein can suitably be animal proteins, vegetable proteins or any combination thereof. Animal proteins can include any protein of animal origin (including vertebrate and invertebrate proteins), e.g., proteins derived from mammals, fowl, fish and insects. Examples of suitable animal proteins include those derived from chicken, turkey, beef, lamb, pork, venison, buffalo, duck, kangaroo, shell fish, crustaceans, salmon, tuna, whitefish, etc. They can suitably be derived from muscle meat, organs, tendons, bone, etc. Further suitable animal proteins can include milk or egg derived proteins. Suitable vegetable proteins can include proteins derived from wheat gluten, soy protein isolate, maize, pea, rice, peanuts, hemp, cotton seed, lupine, potato, etc. or blends thereof. The proteins can be in any suitable form, e.g., isolated or partially isolated, concentrated, ground, etc.

As used herein, the melting point of a protein is the temperature at which it changes state from solid to liquid at the pressure selected. The denaturation temperature of a protein can be measured by methods well known in the art, for example by use of a rubber process analyzer. As a rubber process analyzer, a respective analyzer from TA Instruments, Wetzlar, Germany, Model RPA Elite, can be used, measuring viscoelastic properties of protein/moisture samples pursuing a temperature sweep analysis delivering a protein melting range.

As used herein, the terms “scraped surface heat exchanger” or “SSHE” refers to a mechanical device having a heated surface and a device for dislodging material from the heated surface by scraping.

As used herein, the term “weight percent” is meant to refer to the quantity by weight of a constituent or component, for example, in the pet food composition as a percentage of the overall weight of the pet food composition. The term “weight percent” can also refer to the quantity by weight of a constituent or component, for example, in the meat analogue as a percentage of the overall weight of the meat analogue. The terms “weight percent,” “wt-%,” “wt. %”, and “wt %” are used interchangeably.

### 5.2 Methods of Making Meat Analogues

The present disclosure provides for processes and apparatuses for the production of meat analogues. In certain embodiments, the process can include preparing a meat batter in a mixer. The meat batter can include protein and can be prepared by mixing water, raw material of meat and/or meat by-product, and optionally further ingredients. The meat batter can be conveyed by means of a first positive displacement pump to a single heating unit. The single heating unit can include a single scraped surface heat exchanger (SSHE). The meat batter can be heated in the single heating unit to a temperature above the melting temperature of the protein to produce a heat-treated product. The heat-treated product can be transferred to a cooling unit by means of a second positive displacement pump. The heat-treated product can be cooled by moving through the cooling unit, so that the heat-treated product reaches a temperature below water boiling temperature at ambient pressure when exiting the cooling unit. The cooled heat-treated product can be divided into pieces.

In certain embodiments, the process can include preparing a meat batter in a mixer. The meat batter can include protein and can be prepared by mixing water, raw material of meat and/or meat by-product, and optionally further ingredients. In certain embodiments, the meat batter can be prepared using a mixer. For example, e.g., in step a), the mixer can be an in-line mixer, whereby the product components can be continuously mixed to form a homogenous mixture. Additionally, in certain embodiments, an off-line high shear mixer can be used. For example, and not by way of limitation, suitable in-line or off-line mixers can include Reflector® mixers (LIPP Mischtechnik GmbH, Mannheim, Germany).

In certain embodiments, the meat batter (e.g., obtained in step (a)) can be conveyed to a single heating unit. In certain embodiments, one or more first positive displacement pump can convey the meat batter to the single heating unit. The one or more first positive displacement pump can exert a pressure to convey the meat batter through the heating process. The pressure of the one or more first positive displacement pumps can range from about 0.1 bars to about 40 bars, from about 0.4 bars to about 30 bars, or from 0.5 to 22 bars. In particular embodiments, the pressure of the one or more first positive displacement pumps can be about 0.1 bars, about 0.4 bars, about 0.5 bars, about 3 bars, about 5 bars, about 10 bars, about 15 bars, about 30 bars, about 35 bars, or about 40 bars. Non-limiting examples of the one or more first positive displacement pumps can include melt pumps, gear pumps, lobe pumps, rotary piston pumps or eccentric screw pumps.

In certain embodiments, the meat batter can be heated in the single heating unit. The single heating unit can include a single scraped surface heat exchanger (SSHE). In accordance with the present disclosure, processes of the present disclosure can include one heating unit that can include one scraped surface heat exchanger (S SHE). Thus, in certain embodiments, processes of the present disclosure can consist of one heating unit that consists of one scraped surface heat exchanger (SSHE). For example, a suitable scraped surface heat exchanger can include a tubular device with a heated jacket surrounding its outer wall, through which heat can be transmitted. Such a tubular device can include a center rotor or shaft with scrapers affixed thereto. When the center rotor or shaft rotates, the scrapers can remove product from an inner wall of the tubular device. In certain embodiments, the center rotor of shaft can operate at a speed of from about 100 rpm to about 500 rpm, from about 150 rpm to about 400 rpm, from about 200 rpm to about 300 rpm, about 200 rpm, about 250 rpm, or about 300 rpm. In use, a mixture of ingredients can be fed into one end of the tubular device and pushed through the device. The heating and the motion through the annular space between the heated inner wall of the cylinder and the center rotor can result in a transformation of the mixture. Scraped surface heat exchangers can have the advantage of moving the ingredient mixture constantly through a pipe or similar hollow cylinder that can be arranged such that heat is applied to its external surface. This can be accomplished by encasing the pipe or cylinder in a water bath that can be maintained at a desired temperature, e.g., by encasing the pipe or cylinder in a thermal agent medium, steam chamber, thermo-oil or other suitable heated medium that can be maintained at the desired temperature. In certain embodiments, an external electrical heated outer temperature source can be used. The temperature difference between the interior and exterior of the scraped surface heat exchanger can cause the ingredient mixture to be heated through indirect heating. Scraped surface heat exchangers are well known in the art. In certain embodiments, the single heating unit can include a microwave heating unit, a radio frequency heating unit, an ultra sound heating unit or an Ohmic heating unit.

In certain embodiments, the single heating unit can be operated with different temperature zones of applied heating medium and/or steam along its length from and entrance to an exit thereof. In particular embodiments, the single heating unit can be operated with different temperature zones with increasing temperatures from the entrance to the exit of the single heating unit. In certain embodiments, the single heating unit can be operated with an incremental temperature increase. Thus, in certain embodiments, a temperature of the entrance of the single heating unit can be lower than a temperature of the exit of the single heating unit. In alternate embodiments, the single heating unit can be operated with varying temperature zones from the entrance to the exit of the single heating unit. In certain embodiments, this could be realized by using several zones that can be individually heated. For example, and not by way of limitation, the single heating unit can be surrounded by several coats each having an individual steam supply at different temperatures.

In certain embodiments, the single heating unit can include at least two temperature zones, at least three temperature zones, at least four temperature zones, or at least five temperature zones. In certain embodiments, the single heating unit can include more than five temperature zones. In particular embodiments, the single heating unit can include at least two temperature zones with temperatures of the applied heating medium and/or steam ranging from about 50° C. to about 170° C., respectively, from the entrance to the exit of the single heating unit. Thus, in certain embodiments, the single heating unit can include a first temperature zone of about 50° C. and a second temperature zone of about 170° C. For example, and not by way of limitation, in certain embodiments, the single heating unit can include five temperature zones with temperatures of the applied heating medium and/or steam ranging from about 50° C., about 80° C., about 110° C., about 140° C., and 170° C., respectively. Thus, in certain embodiments, the single heating unit can include a first temperature zone of about 50° C.; a second temperature zone of about 80° C.; a third temperature zone of about 110° C.; a fourth temperature zone of about 140° C.; and a fifth temperature zone of about 170° C. Such a configuration of the first heating unit can limit the temperature difference of the meat batter to a surface of the single heating unit to be between about 7° C. and about 50° C., about 8° C. and about 35° C., or about 10° C. and about 30° C. In particular embodiments, the configuration of the temperature zones of the first heating unit can limit the temperature different of the meat batter to the surface of the single heating unit to be about 7° C., about 8° C., about 10° C., about 15° C., about 20° C., about 25° C., about 30° C., about 35° C., about 40° C., or about 50° C. It was surprisingly and advantageously found that a first heating unit having five different temperature zones as disclosed herein avoided overheating of the meat batter and improved palatability of the finally produced meat analogue. A person skilled in the art will appreciate a wide variety of temperatures for each temperature zone, amount of temperature zones, and arrangement of temperature zones within the single heating unit are suitable for use with the processes of the present disclosure.

In certain embodiments, upon entering the single heating unit, the meat batter can have a temperature of from about 10° C. to about 35° C., from about 15° C. to about 30° C., or from about 15° C. to about 25° C. In particular embodiments, the meat batter can have a temperature of about 10° C., about 15° C., about 18° C., about 20° C., about 22° C., about 25° C., about 30° C., or about 35° C. upon entering the single heating unit. The meat batter can suitably be pumped into the single heating unit at a pressure of from about 800 kPa to about 2000 kPa, from about 900 kPa to about 1500 kPa, or from about 1000 kPa to about 1250 kPa. In particular embodiments, the meat batter can be pumped into the single heating unit at a pressure of about 800 kPa, about 900 kPa, about 1000 kPa, about 1200 kPa, about 1250 kPa, about 1500 kPa, about 1800 kPa, or about 2000 kPa. In certain embodiments, the meat batter can be heated as it passes through the unit, e.g., by supplying a heat jacket with a liquid heating medium and/or steam. In certain embodiments, a pressure in the single heating unit can be in a range of from about 800 kPa to about 2000 kPa, from about 800 kPa to about 1800 kPa, from about 1000 kPa to about 1800 kPa, from about 1000 kPa to about 1500 kPa, or from about 1000 kPa to about 1250 kPa. In particular embodiments, the pressure in the single heating unit can be about 800 kPa, about 900 kPa, about 1000 kPa, about 1200 kPa, about 1250 kPa, about 1500 kPa, about 1800 kPa, or about 2000 kPa. This pressure range can allow for efficient energy transfer (ensuring that water within the meat batter will maintain liquid status) and reduction of wear of the equipment, for example, the scrapers in the scraped surface heat exchanger. In certain embodiments, the heat-treated product can be divided into pieces. In certain embodiments, the heat-treated product can be divided at a temperature of from about 40° C. to about 80° C., about 40° C. to about 70° C., about 50° C. to about 80° C., or about 50° C. to about 70° C. In particular embodiments, the heat-treated product can be divided at a temperature at about 40° C., about 45° C., about 50° C., about 55° C., about 60° C., about 65° C., about 75° C., or about 80° C. In certain embodiments, the heat-treated product can be divided at a temperature of at least about 40° C., at least about 50° C., at least about 60° C., or at least about 70° C.

In certain embodiments, the single heating unit can have a volume of from about 10 L to about 20 L, about 15 L to about 20 L, or about 16 L to about 18 L. In particular embodiments, the single heating unit can have volume of about 15 L, about 16 L, about 17 L, about 18 L, or about 20 L. In certain embodiments, the first heating unit can have a surface to volume ratio of about 50 m2/m3 to about 70 m2/m3, or about 60 m2/m3.

The meat batter utilized in the processes of the present disclosure can include a mixture of one or more proteins. The one or more proteins can have differing denaturation temperatures and melting temperatures. In certain embodiments, substantially all the protein in the meat batter can be denatured in the single heating unit. In certain embodiments, in the single heating unit, at least about 50 wt-%, about 60 wt-%, about 70 wt-%, about 80 wt-% or about 90 wt-% of protein, based on the total amount of protein in the meat batter, can be melted. In particular embodiments, substantially all the protein can be melted. In certain embodiments, enough protein can be melted to form a cohesive and continuous outer phase of the heat-treated product that can carry non-melted other proteins, fibers, bone particles, etc.

In certain embodiments, the meat batter can include the one or more proteins, one or more liquid ingredients, and one or more additional ingredients. The meat batter can include from about 60% to about 95%, about 70% to about 95%, or about 80% to about 95% by weight of one or more proteins, based on the total weight of the meat batter. In certain embodiments, the meat batter can include about 60%, about 70%, about 80%, about 90%, or about 90.8% by weight of one or more proteins, based on the total weight of the meat batter. In particular embodiments, the one or more proteins can include meat, animal derivatives, and combinations thereof. A person skilled in the art will appreciate that a wide variety of proteins are suitable for use with the present disclosure. The meat batter can include one or more liquids in an amount of from about 1% to about 10%, about 1% to about 8%, or about 1% to about 5% by weight, based on the total weight of the meat batter. In certain embodiments, the meat batter can include about 1%, about 2%, about 3%, about 4%, about 4.7%, about 5%, about 6%, about 7%, about 8%, about 9%, or about 10% by weight of one or more liquids, based on the total weight of the meat batter. In particular embodiments, the one or more liquid ingredients can include water. A person skilled in the art will appreciate that a wide variety of liquid ingredients are suitable for use with the present disclosure. The meat batter can include one or more additional ingredients in an amount of from about 1% to about 10%, about 1% to about 8%, or about 1% to about 5% by weight, based on the total weight of the meat batter. In certain embodiments, the meat batter can include about 1%, about 2%, about 3%, about 4%, about 4.5%, about 5%, about 6%, about 7%, about 8%, about 9%, or about 10% by weight of one or more additional ingredients, based on the total weight of the meat batter. In particular embodiments, the one or more additional ingredients can include at least one of vitamins, minerals, palatants, colorants, etc. A person skilled in the art will appreciate that a wide variety of additional ingredients are suitable for use with the present disclosure.

In particular embodiments, the meat batter can include from about 70% to about 95% by weight of one or more proteins, from about 1% to about 5% by weight of one or more liquid ingredients, and from 1% to about 5% by weight of one or more additional ingredients, based on the total weight of the meat batter. The one or more meat proteins can include meat and animal derivatives. The one or more liquid ingredients can include water. The one or more additional ingredients can include at least one of vitamins, minerals, palatants, colorants, etc.

In certain embodiments, the meat batter can further include crude protein, moisture, and fat to provide a semi-solid mixture form, for example, in order to achieve a nutritionally complete pet food product. In certain embodiments, the semi-solid mixture can include from about 20% to about 45%, about 25% to about 40%, or about 30% to about 35% crude protein by weight, based on the total weight of the semi-solid mixture. In particular embodiments, the semi-solid mixture can include about 25%, about 30.5%, or about 45% by weight crude protein, based on the total weight of the semi-solid mixture. In certain embodiments, the semi-solid mixture can include from about 40% to about 65%, about 45% to about 60%, or from about 55% to about 60% by weight moisture, based on the total weight of the semi-solid mixture. In particular embodiments, the semi-solid mixture can include about 50%, about 55%, or about 59% moisture by weight, based on the total weight of the semi-solid mixture. In certain embodiments, the semi-solid mixture can include from about 1% to about 10%, about 1% to about 8%, or about 1% to about 5% by weight fat, based on the total weight of the semi-solid mixture. In particular embodiments, the semi-solid mixture can include about 1%, about 4.5%, or about 5% by weight fat, based on the total weight of the semi-solid mixture.

In particular embodiments, the semi-solid mixture can include from about 30% to about 35% by weight crude protein, about 55% to about 60% by weight moisture, and from about 1% to about 5% by weight fat, based on the total weight of the semi-solid mixture. The crude protein can include vegetable protein powder (e.g., one part) containing min. 75% protein (vital wheat gluten).

In certain embodiments, the melting range for the proteins used can be determined, for example, by rheological measurements, wherein the melting range is the temperature range, where after an increase in viscosity due to the denaturing (unfolding) of the proteins a drop of viscosity is observed indicating a change from a suspension of solids into a homogeneous liquid phase. In certain embodiments, the melting point of a protein can be measured by methods well known in the art, for example, by differential scanning calorimetry (DSC). For individual proteins, respective data of denaturation temperature and melting point can be also obtained from references as known in the art.

In certain embodiments, the meat batter can have a viscosity of from about 20,000 cP to about 150,000 cP, from about 50,000 cP to about 125,000 cP, or from about 100,000 cP to about 150,000 cP as measured on a Brookfield instrument with spindle 7 at 15 RPM at room temperature (25° C.). In particular embodiments, the meat batter can have a viscosity of about 20,000 cP, about 50,000 cP, about 75,000 cP, about 100,000 cP, about 125,000 cP, or about 150,000 cP as measured on a Brookfield instrument with spindle 7 at 15 RPM at room temperature (25° C.).

In certain embodiments, the heat-treated product (e.g., of step c)) can be transferred to a cooling unit (e.g., in step d)). In certain embodiments, the heat-treated product can be transferred to the cooling unit by means of one or more second positive displacement pumps. The one or more second positive displacement pumps can exert pressure at the end of the heating unit. The operating pressure of the one or more second positive displacement pumps can start from exceeding the saturated steam pressure of pure water at the exit temperature of the heating unit and could reach pressure levels up to about 100 bars. In certain embodiments, the one or more second positive displacement pumps can have an operating pressure of from about 3 bars to about 80 bars, from about 5 bars to about 60 bars, from about 5 bars to about 40 bars, or from about 10 bars to about 30 bars. In particular embodiments, the one or more second positive displacement pumps can have an operating pressure of about 3 bars, about 5 bars, about 10 bars, about 15 bars, about 20 bars, about 30 bars, about 35 bars, about 40 bars, about 60 bars, or about 80 bars. The one or more second positive displacement pumps can be required, since in the cooling die the heat-treated material can turn from a pumpable liquid or paste into a soft matter solid. Such material needs to be pushed out of the cooling die channel. Thus, a higher pressure can be required. For example and not by way of limitation, the one or more second positive displacement pumps can include melt pumps, gear pumps, lobe pumps or rotary piston pumps.

The heat-treated product can be a layered and/or aligned product formed as the cooled material, e.g., in step e). As the melted material solidifies, a layered fibrous meat analogue structure can be formed. Cooling and/or dividing the maters (e.g., step e) and/or step f)) can be optionally performed under pressure of from about 800 kPa to about 2000 kPa, about 900 kPa to about 1800 kPa, or about 1000 kPa to about 1500 kPa so that the protein solidifies step by step in layers which create a fibrous structure. Thus, in the cooling step, the aggregate of the protein can change from a liquid melt to a (soft matter based) solid phase. This can reflect a non-liquid gel or rubber-like texture that can be cut into smaller pieces.

In other words, the protein setting can be the controlled solidification of melted protein. The formation of meat-like fibers can be the direct result of an appropriately controlled cooling. As described above, if the heat-treated product has been heated above the melting point of the protein, at least part of that protein (or the protein mixture) can also be melted. Once proteins have been brought to the melted state, upon cooling, they can solidify into a strong, elastic mass with leather-like properties. This mass does not easily re-melt and cannot be pumped mechanically. Thus, it is important that, once melted, protein can be maintained in motion and cooled in a cooling unit from which solidified material can be continuously discharged.

In certain embodiments, the heat-treated product can exit the single heating unit at a temperature of from about 140° C. to about 170° C., from about 145° C. to about 165° C., from about 150° C. to about 160° C., or from about 158° C. to about 160° C. In particular embodiments, the heat-treated product can exit the single heating unit at a temperature of about 140° C., about 145° C., about 150° C., about 155° C., about 158° C., about 159° C., about 160° C., about 165° C., or about 170° C. In certain embodiments, the heat-treated product can be cooled to a temperature below water boiling temperature at ambient pressure in a cooling unit, e.g., using a tubular cooling zone cooled with water. In certain embodiments, the heat-treated product can be cooled to a temperature of less than about 85° C., less than about 80° C., or less than about 70° C. In certain embodiments, a rectangular shaped cooling die design can be used. The heat-treated product can be transferred through the cooling unit, e.g., along a cool surface, and can be formed into a layered fibrous structure as the melt solidifies (as the heat-treated product temperature drops below its melting point). This can occur under pressure and in motion and the protein solidifies step by step in layers to create fibrous structures.

In certain embodiments, the heat-treated product can be divided. Dividing of the heat-treated product can be performed in one or more steps, for example, a first cutting can be performed using a grid cutter followed by a second cutting using a rotary cutter. The resulting meat analogues can be irregular, random or essentially random in shape. Optionally, the resulting meat analogues can be transferred to an inspection station for visual inspection to facilitate quality control, manual or automatic, e.g., using a digital camera and suitable image recognition software.

In particular embodiments, the present disclosure provides a process for the production of a meat analogue, comprising the steps of: a) preparing a meat batter comprising protein by mixing water, raw material of meat and/or meat by-product, and optionally further ingredients, in a mixer; b) conveying the meat batter by means of a first positive displacement pump to a single heating unit comprising a single scraped surface heat exchanger; c) heating the meat batter in the single heating unit to a temperature above the melting temperature of the protein to produce a heat-treated product; d) transferring the heat-treated product to a cooling unit by means of a second positive displacement pump; e) cooling the heat-treated product by moving through the cooling unit, so that the heat-treated product reaches a temperature below water boiling temperature at ambient pressure when exiting the cooling unit; and f) dividing the cooled heat-treated product into pieces. The meat batter can be heated to a temperature of from about 140° C. to about 170° C. The single heating unit can be operated with different temperature zones of applied heating medium and/or steam along its length, optionally with increasing temperatures from an entrance to an exit of the single heating unit. The single heating unit can be operated with an incremental temperature increase. The single heating unit can have a first temperature zone of about 50° C. at the entrance of the single heating unit, and a second temperature zone of about 170° C. at the exit of the single heating unit, wherein the single heating unit optionally comprises at least three different temperature zones, or at least five different temperature zones of about 50° C., about 80° C., about 110° C., about 140° C. and about 170° C., respectively, from the entrance to the exit of the single heating unit. In step c), a temperature difference of the meat batter to a surface of the single heating unit, at all distances from the entrance of the single heating unit, can be between about 7° C. and about 50° C. or between about 10° C. and about 30° C. A viscosity of the meat batter prepared in step a) can be from about 20,000 cP to about 150,000 cP, as measured on a Brookfield instrument with spindle 7 at 15 RPM at room temperature (25° C.). An outlet temperature of the heat-treated material from the single heating unit can be from about 150° C. to about 170° C. The heat-treated product is cooled in the cooling unit to a temperature of less than about 80° C. The meat analogue produced according to the processes disclosed herein can have improved palatability as compared to meat analogues prepared by conventional processes.

In particular embodiments, a meat batter can be fed by means of a first positive displacement pump into a single heating unit. The single heating unit can include a single scraped surface heat exchanger (SSHE) heating unit with a volume of from about 10 L to about 20 L, or about 17 L and a surface to volume ratio of from about 50 m2/m3 to about 70 m2/m3, or about 60 m2/m3 under from about 1000 kPa to about 1500 kPa, or about 1200 kPa product pressure. The SSHE heating unit can be continuously supplied with steam at a temperature of between from about 160° C. to about 175° C., or about 166° C. to about 168° C. and the shaft can be operated from about 150 rpm to about 400 rpm, or from about 200 rpm to about 300 rpm. The outlet temperature of the material from the SSHE heating unit heating unit can be between from about 140° C. to about 170° C., or from about 158° C. to about 160° C. The material can then be directed to a cooling unit by a second positive displacement pump. In the cooling unit, the temperature of the material can be reduced to a temperature of less than about 80° C. or less than about 70° C. The solid material obtained can be cut to produce meat analogues with internal fibrosity.

In particular embodiments, a meat batter can be conveyed by means of a first positive displacement pump to a single heating unit comprising a scraped surface heat exchanger (SSHE) heating unit. The SSHE heating unit can include five (5) zones of different temperatures of applied steam from the entrance to the exit of the SSHE heating unit which can be increasing temperatures, e.g., about 50° C., about 80° C., about 110° C., about 140° C., and about 170° C., respectively. Different temperature zones can be provided in surrounding each zone by a different coat having an individual steam supply at appropriate temperature. The meat batter entering the SSHE heating unit can have a temperature of from about 10° C. to about 35° C., or about 30° C. The meat batter can be conveyed through the SSHE heating unit, so that the temperature difference of the meat batter to a surface of the single heating unit, at all distances from the entrance of the single heating unit, can be in the range of between about 7° C. and about 50° C., or between about 10° C. and about 30° C. The outlet temperature of the material from the single heating unit can be between from about 140° C. to about 170° C., or from about 158° C. to about 160° C. The material can then be directed to a cooling unit by a second positive displacement pump. In the cooling unit, the temperature of the material can be reduced to a temperature of less than about 80° C. or less than about 70° C. The solid material obtained can be cut to produce meat analogues with internal fibrosity.

The present disclosure provides meat analogues prepared by the disclosed processes. Such meat analogues can have improved palatability as compared to meat analogues prepared by conventional processes. The present disclosure further provides human and pet food products including the meat analogue produced by the processes of the present disclosure. In certain embodiments, a human food product comprises a meat analogue of the present disclosure. In certain embodiments, a pet food product comprises a meat analogue of the present disclosure.

The present disclosure provides apparatuses for the production of meat analogues which have all the advantages discussed for the processes. The apparatus of the present disclosure can include a mixer. The apparatus can further include one or more first positive displacement pumps, located downstream the mixer. The apparatus can further include a single heating unit. The single heating unit can include a single scraped surface heat exchanger, located downstream the first positive displacement pump. The apparatus can further include one or more second positive displacement pumps, located downstream the single heating unit. The apparatus can further include a cooling unit, located downstream the one or more second positive displacement pumps. The apparatus can further include a dividing unit, located downstream the cooling unit.

In certain embodiments, the first and second positive displacement pumps can be gear pumps, melt pumps, lobe pumps or other rotary piston pumps.

The apparatus can also additionally include one or more of: i) a grinder for grinding meat, ii) a conditioning unit, iii) a packaging unit, or iv) a sterilization unit installed downstream of the single heating unit. In certain embodiments, the processes and apparatus of the present disclosure do not utilise and/or comprise a steam tunnel.

The single heating unit can suitably be slightly tilted. In such embodiments, the heat-treated product can enter the single heating unit from below, allowing air to be forced out of the unit, ensuring improved heat transfer.

In particular embodiments, the present disclosure provides an apparatus for the production of a meat analogue comprising: i) a mixer; ii) a first positive displacement pump, located downstream the mixer; iii) a single heating unit comprising a single scraped surface heat exchanger; located downstream the first positive displacement pump; iv) a second positive displacement pump, located downstream the single heating unit; v) a cooling unit, located downstream the second positive displacement pump; and vi) a dividing unit, located downstream the cooling unit. The first and second positive displacement pumps can be gear pumps or rotary lobe pumps. The apparatus can additionally comprise one or more of: i) a grinder; ii) a conditioning unit; iii) a packaging unit; or iv) a sterilization unit installed downstream of the heating unit. The single heating unit can be operable to have different temperature zones of applied heating medium and/or steam along its length, optionally with increasing temperatures from an entrance to an exit of the single heating unit. The single heating unit can be operable to have an incremental temperature increase. The cooling unit can be operable to cool a heat-treated product to a temperature of less than about 80° C. The dividing unit can be operable to perform a first cutting using a grid cutter followed by a second cutting using a rotary cutter.

### 5.3 Methods of Using Meat Analogues

In certain non-limiting embodiments, the meat analogues produced by processes and apparatuses of the present disclosure can be used alone or incorporated into pet or human food products. Such end food products can include, for example, and not by way of limitation, a mixed pet food product. Meat analogues of the present disclosure can be incorporated into pates, loaves and chunk in sauce formats. For example, meat analogues of the present disclosure can be incorporated in “chunk in sauce” products, e.g., “chunk and gravy”, “chunk and jelly” or “chunk and mousse” products.

### 6. EXAMPLES

The presently disclosed subject matter will be better understood by reference to the following Examples, which are provided as exemplary of the disclosure, and not by way of limitation.

### Example 1: Process for Production of Meat Analogues (Heating Unit—Single Temperature Zone)

The present Example provides processes for the production of meat analogues with a heating unit having one temperature zone.

Three parts of a slurry containing 90.8% meat and animal derivatives, 4.7% water, and 4.5% of at least one of vitamins, minerals, palatants, colorants, etc. (all percentages are weight percentages based on the total weight of the slurry) as to achieve a nutritionally complete cat food finished product were mixed with one part vegetable protein powder containing min. 75% protein (vital wheat gluten) to form a semi-solid mixture containing 30.5% crude protein, 59% moisture and 4.5% fat (all percentages of the semi-solid mixture are based on the total weight of the semi-solid mixture).

The mixture was fed by means of a first positive displacement pump into a single heating unit comprising a single scraped surface heat exchanger (SSHE) heating unit with a volume of approx. 17 L and a surface to volume ratio of 60 m²/m³ under 1,200 kPa product pressure. The SSHE heating unit was continuously supplied with steam at a temperature between 166-168° C. and the shaft was operated at 200 rpm-300 rpm. The outlet temperature of the material from the SSHE heating unit heating unit was between 158-160° C. The material was then directed to a cooling area by a second positive displacement pump through which the temperature of the material was brought down to below 80° C. The solid material obtained was cut to produce meat analogues with internal fibrosity.

### Example 2: Process for the Production of Meat Analogues (Heating Unit—Multiple Temperature Zones)

The present Example provides processes for the production of meat analogues in accordance with certain embodiments of the present disclosure with a heating unit having multiple temperature zones.

A meat batter was prepared as provided in Example 1. The meat batter was then conveyed by means of a first positive displacement pump to a single heating unit comprising a SSHE heating unit. The SSHE heating unit comprised five (5) zones of different temperatures of applied steam from the entrance to the exit of the SSHE heating unit of 50° C., 80° C., 110° C., 140° C., and 170° C., respectively, which different temperature zones were provided in surrounding each zone by a different coat having an individual steam supply at appropriate temperature. The meat batter entering the SSHE heating unit had a temperature of about 30° C. and was conveyed through the SSHE heating unit, so that the temperature difference of the meat batter to a surface of the single heating unit, at all distances from the entrance of the single heating unit, was in the range of between about 10° C. and about 30° C. The outlet temperature of the material from the single heating unit was between 158-160° C. The material was then directed to a cooling area by a second positive displacement pump through which the temperature of the material was brought down to below 80° C. The solid material obtained was cut to produce meat analogues with internal fibrosity.

### Example 3: Palatability Testing (Meat Analogues Example 1 and Example 2)

The present Example provides palatability testing of the meat analogues prepared in accordance with Example 1 and Example 2.

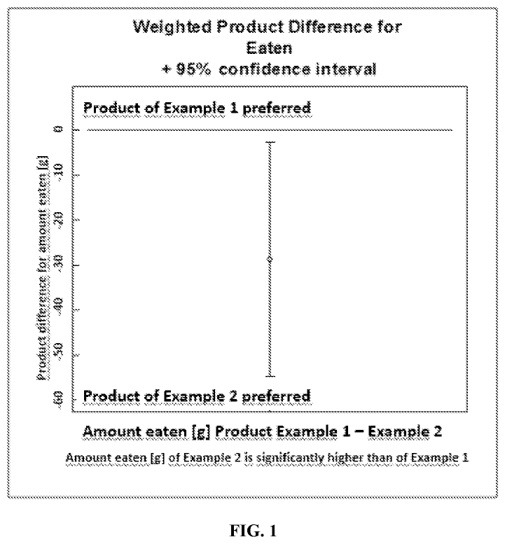

The meat analogues of Example 1 and Example 2 were each mixed with the same conventional sauce at a 1:1 weight ratio, filled into 100 g pouches and retorted to obtain commercially sterile wet cat food. Both products from Examples 1 and 2 were offered to 29 cats in a preference test, in which the same amount of each product was offered simultaneously to cats. The amount of consumed food by the cats was measured by comparing the weighted amount offered versus the weighted amount left in the feeding bowl. The results of the preference feeding tests are provided in FIG. 1.

As shown in FIG. 1, a significant difference in amount eaten of the product from Example 2 was demonstrated. Surprisingly, the cat palatability of a product produced in a SSHE heating unit with five (5) separately heated jackets resulting in five (5) different temperature zones, where the temperature difference of the heated surface towards the product temperature was limited to range from 10° C. towards 30° C. was significantly improved versus a SSHE heating unit which was heated at the same high temperature in only one heating jacket. This was measured by comparing the amount eaten of both products. For the product including the meat analogue produced in Example 2, the difference in amount eaten was on average 28.7 g higher than the product including the meat analogue produced in Example 1.

Although the presently disclosed subject matter and its advantages have been described in detail, it should be understood that various changes, substitutions and alterations can be made herein without departing from the spirit and scope of the application as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the presently disclosed subject matter, processes, machines, manufacture, compositions of matter, means, methods, or steps, presently existing or later to be developed that perform substantially the same function or achieve substantially the same result as the corresponding embodiments described herein can be utilized according to the presently disclosed subject matter. Accordingly, the appended claims are intended to include within their scope such processes, machines, manufacture, compositions of matter, means, methods, or steps.

For any patents, patent applications, publications, product descriptions, and protocols are cited throughout this application, the disclosures of all of which are incorporated herein by reference in their entireties for all purposes.

1. A process for the production of a meat analogue, comprising the steps of:
a) preparing a meat batter comprising protein by mixing in a mixer at least:
water and at least one of raw material of meat and meat by-product;
b) conveying the meat batter via a first positive displacement pump to a single heating unit comprising a single scraped surface heat exchanger;
c) heating the meat batter in the single heating unit to a temperature above the melting temperature of the protein to produce a heat-treated product;
d) transferring the heat-treated product to a cooling unit via a second positive displacement pump;
e) cooling the heat-treated product by moving through the cooling unit, so that the heat-treated product reaches a temperature below water boiling temperature at ambient pressure when exiting the cooling unit; and
f) dividing the cooled heat-treated product into pieces,
wherein the single heating unit is operated with different temperature zones.

2. The process of claim 1, wherein the meat batter is heated to a temperature of from about 140° C. to about 170° C.

3. The process of claim 1, wherein the single heating unit is operated with different temperature zones of applied heating medium and/or steam along its length, optionally with increasing temperatures from an entrance to an exit of the single heating unit.

4. The process of claim 3, wherein the single heating unit is operated with an incremental temperature increase.

5. The process of claim 3, wherein the single heating unit has a first temperature zone of about 50° C. at the entrance of the single heating unit, and a second temperature zone of about 170° C. at the exit of the single heating unit, wherein the single heating unit optionally comprises at least three different temperature zones, or at least five different temperature zones of about 50° C., about 80° C., about 110° C., about 140° C. and about 170° C., respectively, from the entrance to the exit of the single heating unit.

6. The process of claim 1, wherein, in step c), a temperature difference of the meat batter to a surface of the single heating unit, at all distances from the entrance of the single heating unit, is between about 7° C. and about 50° C. or between about 10° C. and about 30° C.

7. The process of claim 1, wherein a viscosity of the meat batter prepared in step a) is from about 20,000 cP to about 150,000 cP, as measured on a Brookfield instrument with spindle 7 at 15 RPM at room temperature (25° C.).

8. The process of claim 1, wherein an outlet temperature of the heat-treated material from the single heating unit is from about 150° C. to about 170° C.

9. The process of claim 1, wherein the heat-treated product is cooled in the cooling unit to a temperature of less than about 80° C.

10. The process of claim 1, wherein the meat analogue produced has improved palatability as compared to meat analogues prepared by conventional processes.

11. A meat analogue prepared by a process of:
a) preparing a meat batter comprising protein by mixing in a mixer at least: water and at least one of raw material of meat and meat by-product;
b) conveying the meat batter via a first positive displacement pump to a single heating unit comprising a single scraped surface heat exchanger;
c) heating the meat batter in the single heating unit to a temperature above the melting temperature of the protein to produce a heat-treated product;
d) transferring the heat-treated product to a cooling unit via a second positive displacement pump;
e) cooling the heat-treated product by moving through the cooling unit, so that the heat-treated product reaches a temperature below water boiling temperature at ambient pressure when exiting the cooling unit; and
f) dividing the cooled heat-treated product into pieces,
wherein the single heating unit is operated with different temperature zones.

12. A human food product comprising the meat analogue of claim 11.

13. A pet food product comprising the meat analogue of claim claim 11.

14. An apparatus for the production of a meat analogue comprising:
i) a mixer;
ii) a first positive displacement pump, located downstream the mixer;
iii) a single heating unit comprising a single scraped surface heat exchanger, located downstream the first positive displacement pump;
iv) a second positive displacement pump, located downstream the single heating unit;
v) a cooling unit, located downstream the second positive displacement pump; and
vi) a dividing unit, located downstream the cooling unit,
wherein the single heating unit is operable to have different temperature zones.

15. The apparatus of claim 14, wherein the first and second positive displacement pumps are gear pumps or rotary lobe pumps.

16. The apparatus of claim 14 additionally comprising one or more of:
i) a grinder;
ii) a conditioning unit;
iii) a packaging unit; or
iv) a sterilization unit installed downstream of the heating unit.

17. The apparatus of claim 14, wherein the single heating unit is operable to have different temperature zones of applied heating medium and/or steam along its length, optionally with increasing temperatures from an entrance to an exit of the single heating unit.

18. The apparatus of claim 17, wherein the single heating unit is operable to have an incremental temperature increase.

19. The apparatus of claim 14, wherein the cooling unit is operable to cool a heat-treated product to a temperature of less than about 80° C.

20. The apparatus of claim 14, wherein the dividing unit is operable to perform a first cutting using a grid cutter followed by a second cutting using a rotary cutter.
